(19) United States
(12) Patent Application Publication
(10) Pub. No.: US 2010/0237044 A1
(43) Pub. Date: Sep. 23, 2010

(54) PROCESS FOR BONDING A MATERIAL INTO A SOLID SURFACE MATERIAL

(76) Inventors: William G. Price, Gregory, MI (US); William M. Price, Chelsea, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 12/408,782

(22) Filed: Mar. 23, 2009

(51) Int. Cl. B05D 5/06; B44C 1/22

(52) U.S. Cl. 216/41; 427/271; 216/94

(57) ABSTRACT

A process for bonding a material into a solid surface material that includes the steps of a) etching a pattern into a solid surface material; b) providing a contrasting colored compound; c) applying the contrasting colored compound into the etched pattern within a predetermined time; and d) allowing the applied material to harden and form a chemical bond between the solid surface material and the contrasting colored compound.

### FIELD OF THE INVENTION

The invention relates to a process for bonding a contrasting colored material into a solid surface material.

### BACKGROUND OF THE INVENTION

Solid surface materials are known in the art and may be utilized in various applications including indoor and outdoor applications. Solid surface materials may come in various colors from light colored solid surface materials to dark solid surface materials. Additionally, solid surface materials may be incorporated in various structures used in differing environments such as in outdoor locations as a marker or underwater.

In some applications it may be desirable to apply images or text onto a solid surface material. Current prior art techniques include applying various images using a paint or silicone or other coating material. However, such paints or coatings are subject to wear and degradation from exposure to the environment and do not provide a long lasting solution. There is therefore a need in the art for a process to provide a long lasting and permanent bonding of the images or text into a solid surface material.

Etching of various materials including granite as well as other materials is generally performed on dark materials that may provide some contrast between the etching and the bulk material. However, even on dark colored materials the contrast between the etched and the bulk material is often insufficient to provide an easily seen design. Further, light colored materials are often not utilized in an etching application as there is insufficient contrast provided between the etched and the bulk material. There is therefore a need in the art for a process of bonding material into a solid surface material that overcomes the problems with lack of contrast in the prior art.

### SUMMARY OF THE INVENTION

In one aspect, there is provided a process for bonding a material into a solid surface material that includes the steps of a) etching a pattern into a solid surface material; b) providing a contrasting colored compound; c) applying the contrasting colored compound into the etched pattern within a predetermined time; and d) allowing the applied material to harden and form a chemical bond between the solid surface material and the contrasting colored compound.

In another aspect, there is described a process for bonding a material into a solid surface material that includes the steps of a) etching a pattern into a solid surface material; b) preparing a contrasting colored compound including providing a chemical compound that chemically bonds to the solid surface and mixing with a coloring agent; c) applying the contrasting colored compound into the etched pattern within a predetermined time; and d) allowing the applied material to harden and form a chemical bond between the solid surface material and the contrasting colored compound.

In a further aspect, a process for bonding a material into a solid surface material includes the steps of a) etching a pattern into a solid surface material; b) preparing a contrasting colored compound including reacting a first chemical agent with a second chemical agent to form the chemical compound that chemically bonds to the solid surface and mixing with a coloring agent; c) applying the contrasting colored compound into the etched pattern within a timeframe measured from the start of step b) such that the contrasting colored compound has a sufficient viscosity to be spread into the etched pattern; and d) allowing the applied material to harden and form a chemical bond between the solid surface material and the contrasting colored compound.

### BRIEF DESCRIPTION OF THE DRAWINGS

FIG. 1 is a flow diagram of the process for bonding a material into a solid surface material.

### DETAILED DESCRIPTION OF THE PREFERRED EMBODIMENTS

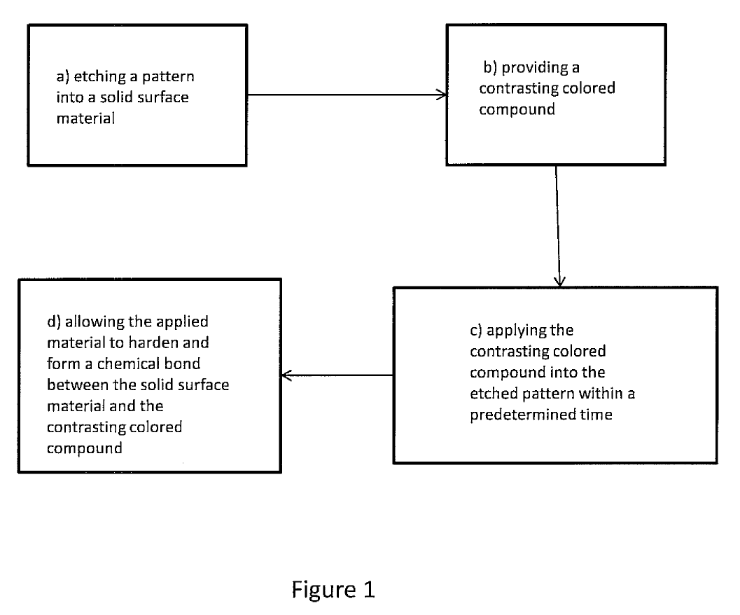

Referring to FIG. 1, there is shown a flow diagram of a process for bonding a material into a solid surface material. The process includes a first step of etching a pattern into a solid surface material. A second step includes preparing a contrasting colored compound. A following step includes applying the contrasting colored compound into the etching pattern within a predetermined timeframe. Next another step allowing the applied material to harden and form a chemical bond between the solid surface and the contrasting colored compound is performed.

The step of etching a pattern into a solid surface material may be performed using various machines and techniques. In one aspect, a laser, sandblaster or machine tool that may be linked with a computer system may be programmed to etch a pattern into a solid surface material. Various solid surface materials may be utilized including Corian, Avonite or other solid surface type materials. Various patterns including designs as well as lettering may be etched into the solid surface material. The etching in one aspect may have a depth of at least 1/128¹¹ of an inch measured from a viewed surface of the solid surface material. In this manner, the depth of the etched pattern is sufficient to receive an amount of contrasting colored compound such that the etching is easily viewed by an observer. In one aspect, following the etching of a pattern into the solid surface material, excess material may be removed from the etched area such that it does not interfere with application of the contrasting colored compound. Various techniques for removing the excess material include vacuuming, brushing or blowing the excess material from the etched pattern.

Following the step of etching a pattern into the solid surface material, next a contrasting colored compound is prepared. In one aspect, the contrasting colored compound is prepared utilizing a chemical compound that chemically bonds to the solid surface material that is mixed with a coloring agent. Various coloring agents such as dyes or food colorings that are compatible with the chemical compound may be mixed in varying amounts such that the coloring is easily viewed by an observer and provides sufficient contrast with the solid surface material. The step of preparing the contrasting colored compound may be performed by hand or may be automated with an appropriate mixing device.

In one aspect, the chemical compound that chemically bonds to the solid surface may include a first chemical agent that is reacted with a second chemical agent to form the chemical compound that chemically bonds to the solid surface material. Typically in such binary systems the reaction of the first chemical agent with the second chemical agent triggers the hardening process of the chemical compound. In this situation, it is desirable to perform the preparation step and the application steps within a predetermined amount of time such that the contrasting colored compound has a sufficient viscosity to allow application into the etched pattern. Various predetermined times may be utilized for differing contrasting colored compounds and will be discussed in more detail below.

Following tie step of preparing a contrasting colored compound next the contrasting colored compound is applied into the etched pattern within the predetermined amount of time. The contrasting colored compound may be applied into the etched pattern using a squeegee, float or other means to force the contrasting colored compound within the etched pattern. In this manner, the contrasting colored compound is brought into contact with the solid surface material allowing the chemical reaction between the solid surface material and colored compound. In one aspect, the contrasting colored compound is applied into the etched portion of the solid surface such that it is flush with the non-etched surface of the solid surface material. In this manner, the contrasting colored compound will form a seamless surface with the bulk solid surface material. In another aspect, the contrasting colored compound may be applied into the etched portion of the solid surface so that it is below a non-etched surface of the solid surface material. In this manner, a relief or differing height between the solid surface material and the contrasting colored compound may be formed to provide a broken surface that may allow a different visual perception by an observer. Additionally, the contrasting colored compound may have various finishes. In one aspect, the contrasting colored compound that is applied to the solid surface material may have a differing finish from the solid surface material. In another aspect the contrasting colored compound may have the same finish as the solid surface material. Various finishes including gloss, semi-gloss, matte or other finishes may be achieved utilizing various contrasting colored compounds. Again, utilization of various finishes may provide different visual characteristics of the solid surface material having the bonded contrasting colored compound.

Following the application of the contrasting colored compound into the etched pattern, the applied material is then allowed to harden and form a chemical bond between the solid surface material and the contrasting colored compound. In this manner, the contrasting colored material is permanently joined with the solid surface material to provide a long lasting visual appearance to the solid surface material. Various time periods for allowing the applied material to harden may be utilized. In one aspect, the hardening step may take from 30 to 40 minutes.

Following the step of allowing the applied material to harden, another step may be performed following that step including removing residual contrasting colored material from the etched surface that may be outside of the boundary of the etching. Excess residual material may be removed utilizing sanding, polishing or other techniques. In another aspect, the step of removing residual material may be avoided by performing the step of masking the solid surface material prior to the step of etching the solid surface material. In this manner, a film or other masking may be applied to the solid surface material such that excess or residual contrasting colored material does not bond with the solid surface material. In this manner, the masking material may be removed after the applied material has had a chance to harden.

In one aspect, and as outlined above, the predetermined amount of time may be measured from the start of the step of preparing the contrasting colored compound and end with the application of the contrasting colored compound. In one aspect, the time period may be less than one minute such that the contrasting colored compound has a sufficient viscosity to flow into the etching pattern formed in the solid surface material. It should be realized that various time periods maybe utilized for different contrasting colored compounds.

### EXAMPLES

In a first example a solid surface material of Corian® was etched utilizing a laser etching tool. Specific patterns may be programmed into a computer linked with the laser etching tool such that a desired pattern is formed in the solid surface. In one aspect, the laser etching tool etched a pattern into the solid surface material at a depth of 1/32 inches. Following the etching of the pattern, excess material was removed from the solid surface utilizing compressed air such that the excess material does not interfere with the bonding of the contrasting colored material with the solid surface material. Following the engraving a contrasting colored compound was prepared utilizing a solid surface joint adhesive that is designed to react with the solid surface material and form a chemical bond. A mix pack with a similar design to a standard caulk gun includes two chemical agents that are separate and will mix in a mixing device positioned at the end of the gun by actuating the gun. Mixing occurred when the trigger was ratcheted forcing the two chemical agents within the adhesive cylinder together through the attached mixing nozzle. The varied hole sizes at the end of the adhesive container properly mixed amounts of each chemical agent. Next a coloring agent of food coloring although any compatible coloring agent may be used was mixed with the adhesive to provide an appropriate colored material. The mixing can be done with an appropriate stirring utensil such that the color is mixed throughout the adhesive. The contrasting colored compound was then applied into the desired etched portion of the solid surface material utilizing a float such that the contrasting colored compound was pressed into the etched pattern and was flush with the surface of the solid surface material. Addition of the color to the adhesive compound provides a contrast from the adhesive material which is designed to match the solid surface material and provide a non-visible joint. The contrasting color that is added to the normally matched color of the adhesive allows the compound to chemically react with the solid surface material and provide an easily viewed contrasting visual effect. The steps of mixing and applying the compound to the solid surface material were performed within 90 to 120 seconds from the initialization of the mixing step such that the compound did not lose a workable viscosity such that application by the float would not be possible.

The applied contrasting colored compound was then allowed to harden for a time of from 30 to 40 minutes. The various steps were repeated for differing colors such that multiple colors may be included within an etch pattern. The hardened contrasting colored compound includes the dye or coloring that is encapsulated within the adhesive and chemically bonds with the solid surface material to resist fading and removal by exposure to various environments.

1. A process for bonding a material into a solid surface material comprising the steps of:
a) etching a pattern into a solid surface material;
b) preparing a contrasting colored compound;
c) applying the contrasting colored compound into the etched pattern within a predetermined time;
d) allowing the applied material to harden and form a chemical bond between the solid surface material and the contrasting colored compound.

2. The process of claim 1 including the step of removing residual contrasting colored material from the etched surface after the applied material has hardened.

3. The process of claim 1 including the step of masking the solid surface material prior to the step of etching the solid surface material.

4. The process of claim 1 including the step of etching a pattern includes etching a design in the solid surface having a depth of at least 1/128^{th} of an inch.

5. The process of claim 1 wherein the etching step is performed with a laser, sandblaster or machine tool.

6. The process of claim 1 wherein the step of preparing a contrasting colored compound includes providing a chemical compound that chemically bonds to the solid surface and mixing with a coloring agent.

7. The process of claim 6 wherein the mixing step includes reacting a first chemical agent with a second chemical agent to form the chemical compound that chemically bonds to the solid surface.

8. The process of claim 1 wherein the predetermined time is less than one minute measured from the start of the step of preparing a contrasting colored compound.

9. The process of claim 1 wherein the step of applying the contrasting colored compound is performed using a float.

10. The process of claim 1 wherein the contrasting colored compound is applied into the etched portion of the solid surface such that it is flush with a non-etched surface of the solid surface material.

11. The process of claim 1 wherein the contrasting colored compound is applied into the etched portion of the solid surface such that it is below a non-etched surface of the solid surface material.

12. The process of claim 1 including repeating steps of b)-d) for each color applied to the solid surface material.

13. The process of claim 1 wherein the hardening step d) is from 30 to 40 minutes.

14. The process of claim 1 wherein the contrasting colored compound applied to the solid surface material has a differing finish from the solid surface material.

15. The process of claim 1 wherein the contrasting colored compound applied to the solid surface material has the same finish as the solid surface material.

16. The process of claim 1 wherein the contrasting colored compound applied to the solid surface material has a gloss finish.

17. The process of claim 1 wherein the contrasting colored compound applied to the solid surface material has a matte finish.

18. A process for bonding a material into a solid surface material comprising the steps of:
a) etching a pattern into a solid surface material;
b) preparing a contrasting colored compound including providing a chemical compound that chemically bonds to the solid surface and mixing with a coloring agent;
c) applying the contrasting colored compound into the etched pattern within a predetermined time;
d) allowing the applied material to harden and form a chemical bond between the solid surface material and the contrasting colored compound.

19. A process for bonding a material into a solid surface material comprising the steps of:
a) etching a pattern into a solid surface material;
b) preparing a contrasting colored compound including reacting a first chemical agent with a second chemical agent to form the chemical compound that chemically bonds to the solid surface and mixing with a coloring agent;
c) applying the contrasting colored compound into the etched pattern within a time frame measured from the start of step b) such that the contrasting colored compound has a sufficient viscosity to be spread into the etched pattern;
d) allowing the applied material to harden and form a chemical bond between the solid surface material and the contrasting colored compound.
